(19) United States
(12) Patent Application Publication
(10) Pub. No.: US 2017/0368869 A1
(43) Pub. Date: Dec. 28, 2017

(54) NON-PNEUMATIC TIRE WITH MULTI-CONNECTION CONNECTING ELEMENTS

(71) Applicants: Steven M. CRON, Greenville, SC (US); Timothy Brett RHYNE, Greenville, SC (US); Compagnie Generale des Etablissements Michelin, Clermont-Ferrand (FR)

(72) Inventors: Steven M CRON, Simsonville, SC (US); Timothy Brett RHYNE, Greenville, SC (US)

(21) Appl. No.: 15/541,309

(22) PCT Filed: Dec. 30, 2015
(86) PCT No.: PCT/US2015/068032

§ 371 Date: Jun. 30, 2017

Related U.S. Application Data
(60) Provisional application No. 62/099,140, filed on Dec. 31, 2014.

(51) Int. Cl. B60B 9/26; B60C 7/14; B60B 9/04; B60C 7/10

(52) U.S. Cl. CPC B60B 9/26; B60B 9/04; B60C 7/14; B60B 2900/551; B60B 2900/133; B60B 2900/1212; B60B 2900/112; B60B 2900/111; B60C 2007/107; B60C 2007/146; B60B 2900/351

(57) ABSTRACT

A non-pneumatic tire (101) having a hub (201) and a compliant outer band (109) connected by connecting members (129) that are intersected by an intermediate band (120) positioned between the hub (201) and compliant outer band (109) forming a plurality of connecting element segments (331,333), each segment having a predominant curvature extending in the same longitudinal direction said direction coinciding with the preferred direction of rotation of the tire (101).

### FIELD OF THE INVENTION

The subject matter of the present disclosure relates generally to tension-based non-pneumatic, structurally supported tires and wheels. More particularly, the invention relates to a tension-based non-pneumatic wheel having load supporting structural elements extending a portion of the width across the tire.

### BACKGROUND OF THE INVENTION

The pneumatic tire is the best known solution for compliance, comfort, mass, and rolling resistance; however, the pneumatic tire has disadvantages in complexity, the need for maintenance, and susceptibility to damage. A device that improves on pneumatic tire performance could, for example, provide more compliance, better control of stiffness, lower maintenance requirements, and resistance to damage.

Conventional solid tires, spring tires, and cushion tires, although lacking the need for maintenance and the susceptibility to damage of pneumatic tires, unfortunately lack its performance advantages. In particular, solid and cushion tires typically include a solid rim surrounded by a resilient material layer. These tires rely on compression of the ground-contacting portion of the resilient layer directly under the load for load support. These types of tires can be heavy and stiff and lack the shock absorbing capability of pneumatic tires.

Spring tires typically have a rigid wood, metal or plastic ring with springs or spring like elements connecting it to a hub. While the hub is thereby suspended by the springs, the inflexible ring has only a small contact area with the road, which offers essentially no compliance, and provides poor traction and steering control.

Non pneumatic tires having a compliant outer band and connecting elements linking the outer band and hub provide improved performance over spring tires. A shear band, also referred to as a “shear ring” or simply an “outer band,” surrounds the connecting members, transferring the load from the footprint of the tire to the top of the tire where the connecting members carry a portion of the load in tension. Increasing the number of connecting elements between the ring and hub enable the use of thinner shear rings. The use of thinner shear rings is desirable because it enables improvements in, among other attributes; mass, cost, rolling resistance, shock absorption and noise.

Reduction in thickness of a web element that is only connected at the hub and at the shear ring on a tire used in a vehicle, such as an automobile, creates a structure that has undesirable dynamic characteristics at highway speeds.

A non-pneumatic, compliant wheel having performance characteristics similar to those of pneumatic tires, while improving on its disadvantages, would overcome the various deficiencies in the art and would be a welcome improvement. Particularly a non-pneumatic, compliant wheel having connecting elements that exhibit improved high speed dynamic stability and torsional stiffness would be particularly useful.

### SUMMARY OF THE INVENTION

Aspects and advantages of the invention will be set forth in part in the following description, or may be obvious from the description, or may be learned through practice of the invention.

Disclosed is a non-pneumatic tire that includes a hub having a central axis and a hub width extending from a first lateral side of said hub to a second lateral side of said hub, a compliant outer band positioned radially outward from said hub, a plurality of connecting members having a radially inner end connected to the hub and a radially outer end connected to the compliant outer band, at least one intermediate band positioned between the hub and the outer band, the at least intermediate band intersecting with each of the connecting members forming multiple connecting member segments, each connecting member segment having a radially inner segment end and a radially outer segment end, wherein each of the connecting member segments possess a curvilinear shape, and the predominant curvature of each of the curvilinear shape extends in the same longitudinal direction.

The tire may possesses a plurality of laterally adjacent rows of connecting members, such as two rows of connecting members, three rows, four rows or more. It may possess, alternatively, a single row of connecting members.

The non-pneumatic tire may possess just one intermediate band as shown in the figures below, or may possess two or more intermediate bands positioned between the compliant outer band and the hub.

Where the non-pneumatic tire possesses just one intermediate band, the band intersects with each of the connecting members to form a first set of radially inward positioned connecting member segments and a second set of radially outward positioned connecting member segments such that the first set of radially inward positioned connecting member segments attached to said hub at the radially inner segment end, and attached to the intermediate band at the radially outer segment end, and the second set of radially outward positioned connecting member segments attached to the intermediate band at the radially inner segment end, and attached to the compliant outer band at the radially outer segment end.

If an imaginary straight line segment for each connecting member segment is drawn between the radially inner segment end and the radially outer segment end of each connecting member segment, a majority of each of said connecting member segment may be positioned on one side of said straight line segment of the connecting member segment, the side being in the same direction for each connecting member segment and the side would be toward the direction of rotation of the tire.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an embodiment of the invention attached to a hub.

FIG. 2 provides a partial side view of an embodiment of the invention.

FIG. 3 provides a perspective view of an embodiment of the invention with a portion of the compliant outer band including a portion of the tread and outer band removed.

FIG. 4 is a perspective view of the outer band, the inner band, the intermediate band and connecting elements of an embodiment of the invention.

FIG. 5 shows a diagrammatic figure of a finite point on a connecting element and some of the Coriolis acceleration forces as the point passes over the contact patch.

The use of identical or similar reference numerals in different figures denotes identical or similar features.

### DETAILED DESCRIPTION OF THE INVENTION

The present invention provides for a non-pneumatic tire having improved high speed performance characteristics. For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

The following terms are defined as follows for this disclosure:

“Axial direction” or the letter “A” in the figures refers to a direction parallel to the axis of rotation of for example, the hub or the wheel as it travels along a road surface, also referred to as the “transverse” direction of the tire.

“Radial direction” or the letter “R” in the figures refers to a direction that is orthogonal to the axial direction and extends in the same direction as any radius that extends orthogonally from the axial direction.

“Equatorial plane” means a plane that passes perpendicular to the axis of rotation and bisects the hub and/or wheel structure.

“Radial plane” means a plane that passes perpendicular to the equatorial plane and through the axis of rotation of the wheel.

“Connecting element segment straight line segment” is a straight line drawn along a plane which is parallel to the equatorial plane between the points of attachment of the connecting element segment, such as, for example, the point of attachment of the connecting element segment to the inner interface band and a point of attachment of the connecting element segment to the intermediate band, or the point of attachment of the connecting element segment to the intermediate band and a point of attachment of the connecting element segment to the outer interface band, or where there are multiple intermediate bands concentrically positioned, the point of attachment of the connecting element segment to the inner intermediate band and a point of attachment of the connecting element segment to the outer intermediate band.

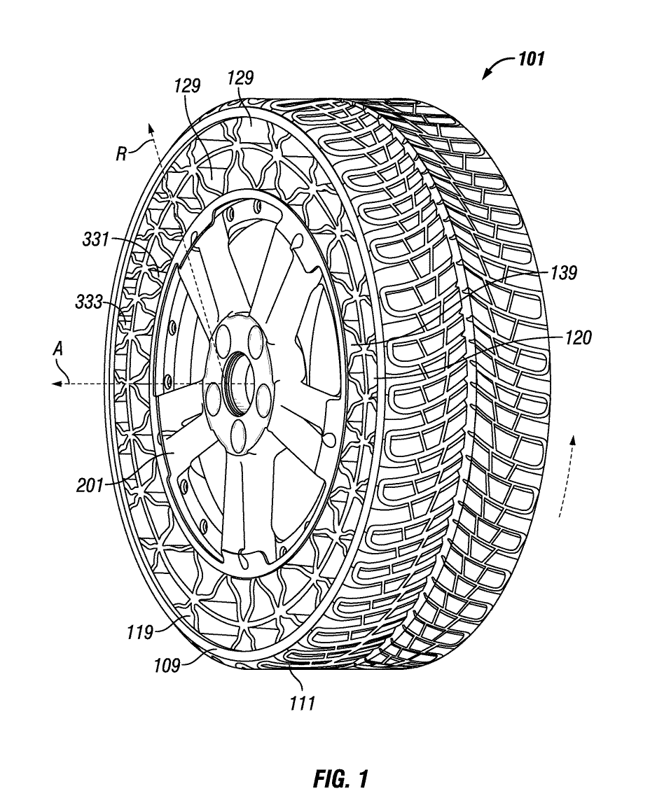

FIG. 1 provides a perspective view of a non-pneumatic wheel 101 which incorporates an embodiment of the invention. For illustration, this particular embodiment possesses a tread sculpture 111 along the outer surface of the outer band 109 which incorporates or is attached to an outer interface band 119. The outer interface band 119 is attached to an inner interface band 139 a plurality of connecting elements 129. The connecting elements 129, also referred to as “web elements” or simply “spokes,” here are shown as webs extending at an angle from the outer interface band 119 to the inner interface band 139. Each of the connecting elements are intersected by an intermediate band 120 positioned between the inner interface band 139 and the outer interface band 119. The intersection of the connecting elements 129 with the intermediate band 120 in this embodiment forms two connecting member segments 331, 333 for each connecting member 129. A radially inward positioned connecting member segment 331 is positioned between the intermediate band 120 and the inner interface band 139 while a radially outward positioned connecting member segment 333 is positioned between the outer interface band 119 and the intermediate band.

In the embodiment shown, each adjacent pair of connecting member segments form a “V” shape as viewed from an axial end of the tire 101. If a radial plane is positioned to extend through the point of connection of the intermediate band 120 with a web element segment 331 or 333, the connecting element element segment straight line segment will be positioned at an angle relative to the radial plane. The larger the angle, the larger the deradialization of the connecting element segment. While the tire is intended to rotate in either direction about the axis of rotation in normal operation, such as might be the case when the vehicle need to reverse, the curved arrow indicates a preferred direction of rotation for high speed use. A hub 201 is shown here in FIG. 1 attached to the inner interface band.

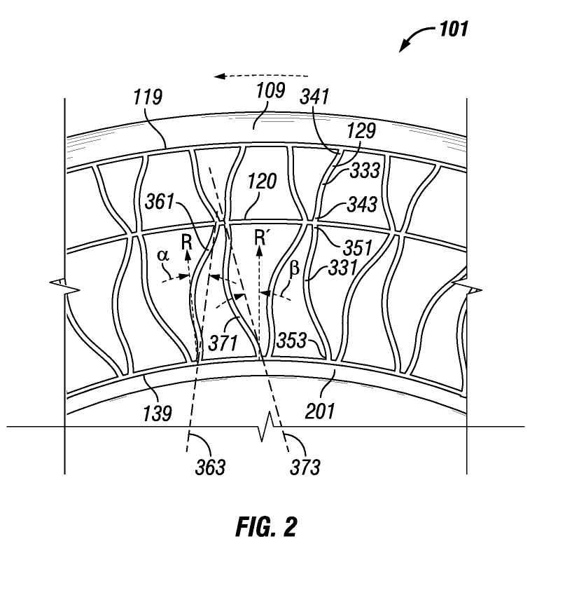

FIG. 2 provides a side view of the non-pneumatic wheel 101 of FIG. 1. The wheel 101 possesses a plurality of connecting elements 129 connecting the outer interface band 119 to the inner interface band 139. At least one intermediate band 120, positioned between the outer interface band 119 and the inner interface band 139 intersects the connecting elements 129. In this embodiment, a single intermediate band 120 is positioned between and concentric with the outer interface band 119 and inner interface band 139 forming a radially outward connecting element segment 333 and a radially inward connecting element segment 331. The radially outward connecting element segment 333 is connected to the outer interface band 119 at the radially outward end 341 of the segment 333 and to the intermediate band 120 at the radially inward end 343 of the segment 333. The radially inward connecting element segment 331 is connected to the intermediate band 120 at the radially outward end 351 of the segment 331 and to the inner interface band 139 at the radially inward end 353 of the segment 331.

In the embodiment shown, each pair of connecting element segments forms a “V” shape with each other. Here a first connecting element segment 361 straight line segment 363 forms an angle α with the radial direction R. Angle α lays the straight line segment 363 away from the preferred direction of rotation of the tire. The adjacent second connecting element segment 371 straight line segment 373 forms an angle β with the radial direction R′ (herein referred to as a negative angle). Angle β lays the straight line segment 373 toward the preferred direction of rotation of the tire (herein referred to as a positive angle). The radially outer segments 333 are similarly arranged, albeit the radially outer segment 333 radially adjacent to the radially inner segment 331 is forms an angle in the opposite direction. Increasing the deradialization angles α and β of the connecting element segments 333, 331 provide increased torsional stability and reduced torsional deflection of the outer band 109 in relation to the hub 201. This increased torsional stiffness reduces the fore and aft movement of the contact patch when acceleration and braking forces are applied to the wheel by the vehicle. Such a reduction in contact patch movement reduces changes of the effective mechanical trail of the suspension and can improve overall vehicle handling. Other embodiments may have more than one intermediate band.

As used herein, the “preferred direction of rotation” is a direction of rotation of the wheel in which it is to be rotated for general high speed use. For example, on a passenger vehicle, the vehicle is generally driven forward. This would be the “preferred direction” of the vehicle, and each wheel will have a corresponding “preferred direction of rotation.” The term “high speed” is used as it is generally understood in the automotive tire manufacturing industry and would include vehicles driving at speeds of 50 miles per hour or greater.

The ratio of the height of the inner set of connecting element segments 331 to the outer connecting segments may vary, but a ratio of 1.8 to 1 combined with a ratio of spoke length to spoke thickness 36 to 1 for the inner set of connecting spoke segments 331 and 18 to 1 for the outer connecting spoke segments 333 have been used in the current embodiment and found suitable.

The majority of the connecting element segment 333 or 331 is positioned to one side of the connecting element segment straight line segment of that particular segment. Particularly, the majority of the connecting element segment is positioned on the side of the straight line segment toward the preferred direction of rotation of the tire such that the segment is predisposed to bend in that direction when the outer band 109 is compressed toward the hub, as when segment rolls through the contact patch as the tire rolls on the ground with a vertical load placed upon the hub 201.

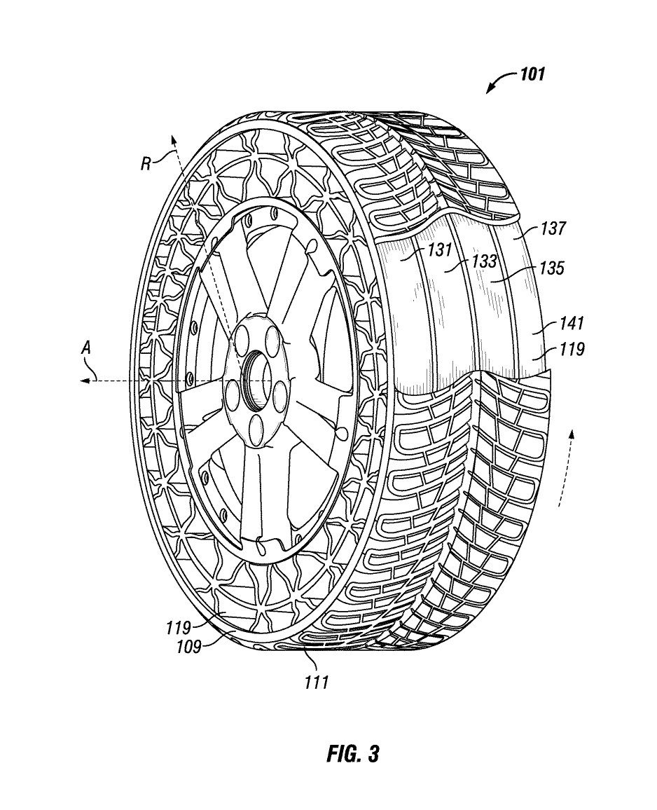

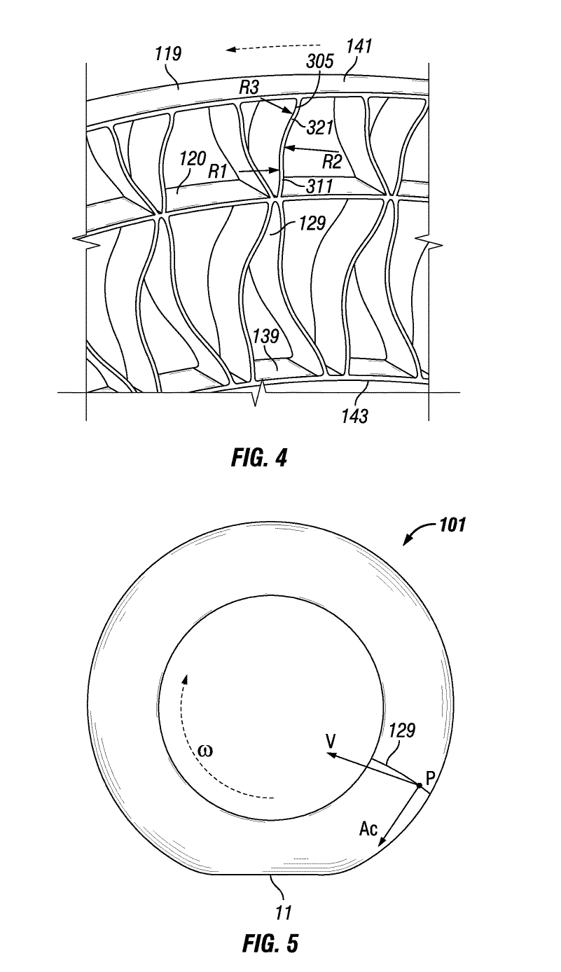

FIG. 3 shows a perspective view of an embodiment of the invention having multiple rows of connecting members where a portion of the compliant outer band 109 (including the outer interface band) has been removed to show the first row of connecting members 131, the second row of connecting members 133, the third row of connecting members 135 and the fourth row of connecting members. In this embodiment, all rows of connecting elements have the same width in the axial direction. Other embodiments may have a single row of connecting members, or may have any other number of connecting members rows.

When assembled radially outward surface 141 of the outer interface band 119 of each of the rows of connecting elements 131, 133, 135, 137 is bound to the radially inner surface of the compliant outer band 109 and the radially inward surface 143 of the inner interface band 139 of each of the rows of connecting elements 131, 133, 135, 137 is bound to the radially outer surface of the hub 201. The binding of the rows of connecting elements to the tread surface can be made by any suitable method including by using an adhesive to bind the components together.

When a load is applied to the hub of the tire, such as when the tire is subject to the weight of the vehicle and vehicle contents and occupants, the compliant outer band 109 is pressed against and conforms to the ground surface. The outline of the area of contact is generally referred to as the contact patch 11, and may include any voids, if present, between the sculptural elements of the tread that do not contact the ground surface. The tread band is closer to the hub at the location of the contact patch and the connecting elements 129 tend to buckle and the web element straight line segments become shorter. As the tire rolls, the various connecting elements 129 pass into and out of the contact patch. The curved shape of each of the connecting elements predisposes each connecting element to buckle in a predetermined direction and manner as they pass through the contact patch. Other forces also act upon the web elements to induce or resist buckling, such as the change in angle of the compliant outer band 109 as it enters the contact patch. This change in angle causes a moment in the connecting element 129 which acts to resist buckling of the connecting element. As the speed of the tire increases, other forces become greater, in particular, it is thought that Coriolis acceleration causes a force to act upon the connecting element as it enters the contact patch in the direction of rotation of the tire. This force acting upon the connecting element 129 as it enters the contact patch pushes the connecting element 129 in the direction of rotation of and in the opposite direction the vehicle is traveling.

As shown in the present embodiments, each connecting element segment 331 or 333 possesses a first curve in a first direction having a radius r₁, a first inflection point 311, a second curve in a second direction having a radius r2, a second inflection point 321, and a third curve in the first direction having a radius r3, as measured by a centerline 305 drawn through the middle of the connecting element segment's thickness. The combined total curvature, or predominant curvature, of the connecting element causes a majority of the connecting element's volume, and therefore also mass, to reside on one side of the connecting element segment's straight line segment. This predisposes the connecting element to buckle toward the opposite side of the straight line segment from which a majority of the connecting element's volume resides such that the middle portion of the connecting element segment moves toward the side on which a majority of the connecting element's volume resides.

As the wheel rotates, the connecting elements roll in and out of the contact patch, and in buckling of each connecting element segment occurs as a result of the summation of forces acting upon the connecting element. Under load at relatively low speeds, say, for example 10 kilometers per hour, with a connecting element having a curvature as shown, each of the web element segment's buckling toward the side of the connecting element's straight line segment 301 on which there is less volume. As the speed increases other forces and moments become greater and the connecting element will buckle as a result of a sum of the forces and moments acting upon it. Each of the connecting elements of the present invention are arranged to be predisposed to buckle when moving through the contact patch in the direction that is away from the direction of rotation of the wheel. That is, the connecting elements of each row of connecting elements all possess a predominant curvature that is in the same direction, and that direction causes a lateral movement of the connecting element toward the direction of rotation of the wheel. At higher speeds, the connecting element moves toward the center of rotation of the wheel and the conservation of angular momentum induces a force directed generally in the same direction as the rotation of the wheel, reinforcing the natural buckling tendencies of the predominant curvature of the connecting element. The web elements predominant curvature in the direction away from direction of the rotation of the tire results in less noise, less vibrations, and reduced fatigue of the connecting members of the wheel.

FIG. 5 diagrammatically shows a wheel 101 and a web element 129 to explain the Coriolis acceleration upon a representative point “P” of a web element 129 as it enters the contact patch 11. Assuming point P has mass, as point P begins to enter the contact patch 11, the point experiences a velocity “V” in the rotating reference frame of the wheel 101 as shown. Assuming “V” and “ω” to be vectors in the rotating reference frame of the wheel 101, then the Coriolis acceleration “Ac” in the rotating reference frame is given by the well-known expression:

Ac=−2ω×V (eqn. 1)

Where the “x” denotes a vector cross product. Point P, as part of the connecting element which is attached to the wheel is restrained from accelerating in the direction of rotation by a deceleration force in the opposite direction. This deceleration force urges the web element in the direction of rotation as the web element enters the contact patch. The Corriolis acceleration has the effect of urging the buckling of the connecting element in the same direction that the predominant curvature urges the connecting element to buckle, stabilizing the web element at high speed as it enters the contact patch. At the exit of contact, point P is experiences deceleration due to the Coriolis effect and the connecting element enters back into a state of tension.

The above models the Coriolis acceleration and forces on a finite portion “P” of the connecting element at a given distance along the connecting element. It should be understood that the Coriolis effect is a result of the radial movement of the mass of the connecting element. It should be understood that the Coriolis acceleration is greater for portions of the connecting element that undergo greater radial movement, such as near the compliant outer band, and less for portions of the connecting element that undergo less radial movement, such as near the inner interface band.

It has been found that circumferential tension generated in the intermediate band reduces the deflection in the outer spokes when the connecting elements are in the contact region (above the footprint). This has the benefit of reducing the amount of compressive loading carried by these connecting elements improving noise and conformation of the tire to road surface conditions.

It has also been found that local intermediate band rotation of the joint between the spokes and intermediate band reduces the strain energy density in the inner connecting element segments which improves long term durability of the connecting elements.

While the present subject matter has been described in detail with respect to specific embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A non-pneumatic tire comprising:
a hub having a central axis and a hub width extending from a first lateral side of said hub to a second lateral side of said hub;
a compliant outer band positioned radially outward from said hub;
a plurality of connecting members having a radially inner end connected to said hub and a radially outer end connected to said compliant outer band;
at least one intermediate band positioned between said hub and said outer band, said at least one intermediate band intersecting with each said connecting member forming multiple connecting member segments, each connecting member segment having a radially inner segment end and a radially outer segment end;
wherein each of said connecting member segments possess a curvilinear shape, and the predominant curvature of each of said curvilinear shape extends in the same longitudinal direction.

2. The non-pneumatic tire of claim 1 wherein:
said tire possesses a plurality of laterally adjacent rows of connecting members.

3. The non-pneumatic tire of claim 1 wherein:
said tire possesses a single lateral row of connecting members.

4. The non-pneumatic tire of any of the above claims wherein each row of connecting members of said tire comprises one intermediate band:
said one intermediate band forms a first set of radially inward positioned connecting member segments and a second set of radially outward positioned connecting member segments;
said first set of radially inward positioned connecting member segments attached to said hub at said radially inner segment end, and attached to said intermediate band at said radially outer segment end;
said second set of radially outward positioned connecting member segments attached to said intermediate band at said radially inner segment end, and attached to said compliant outer band at said radially outer segment end.

5. The non-pneumatic tire of any of the above claims wherein a straight line segment for each connecting member segment is an imaginary straight line drawn between said radially inner segment end and said radially outer segment end of each connecting member segment, wherein the majority of each of said connecting member segment is positioned on one side of said straight line segment of said connecting member segment, said side being in the same direction for each connecting member segment.

6. The non-pneumatic tire of claim 5 wherein said straight line segment for each connecting member segment is positioned at an angle to the radial direction.

7. The non-pneumatic tire of any of the above claims wherein each connecting member segment forms a “v” shape with the adjacent connecting member segment.

8. The non-pneumatic tire of any of the above claims wherein each connecting member segment possesses a first curve in a first direction, a first inflection point, a second curve in a second direction, a second inflection point, and a third curve in the first direction.

9. The non-pneumatic tire of claim 8 wherein the first inflection point is positioned between the first curve and the second curve and wherein the second inflection point is positioned between the second curve and the third curve.

10. The non-pneumatic tire of claim 9 wherein the first curve in the first direction has a first radius, the second curve in the second direction has a second radius and the third curve in the first direction has a third radius.

11. The non-pneumatic tire of any of the above claims wherein said radially outer connecting member segments are shorter than said radially inner connecting member segments.

12. A non-pneumatic tire comprising:
a hub having a central axis and a hub width extending from a first lateral side of said hub to a second lateral side of said hub;
a compliant outer band positioned radially outward from said hub;
a plurality of connecting members having a radially inner end connected to said hub and a radially outer end connected to said compliant outer band;
an intermediate band positioned between said hub and said outer band, said intermediate band intersecting with each said connecting member forming multiple connecting member segments, each connecting member segment having a radially inner segment end and a radially outer segment end;
wherein each of said connecting member segments possess a curvilinear shape, and the predominant curvature of each of said curvilinear shape extends in the same longitudinal direction;
wherein a straight line segment for each connecting member segment is an imaginary straight line drawn between said radially inner segment end and said radially outer segment end of each connecting member segment, wherein the majority of each of said connecting member segment is positioned on one side of said straight line segment of said connecting member segment, said side being in the same direction for each connecting member segment and said direction coinciding with the preferred direction of rotation of the tire.
